(19) United States
(12) Patent Application Publication
(10) Pub. No.: US 2025/0153922 A1
(43) Pub. Date: May 15, 2025

(54) Sealed Container with Heating-Regeneration and Drying-Dehumidifying Functions

(71) Applicant: Elink Plastic & Metal Industrial, Co., Ltd., New Taipei City (TW)

(72) Inventor: Yeh-Yi Chung, New Taipei City (TW)

(21) Appl. No.: 18/651,060

(22) Filed: Apr. 30, 2024

(30) Foreign Application Priority Data
Nov. 9, 2023 (TW) 112212178

(51) Int. Cl. B65D 81/26; B65D 25/04; F26B 5/16

(52) U.S. Cl. CPC B65D 81/268; B65D 25/04; B65D 81/263; F26B 5/16; B65D 2203/02; B65D 2205/02

(57) ABSTRACT

A sealed container with heating-regeneration and drying-dehumidifying functions, including a body, a drying device provided in the body, an electrical connection portion, a sealing structure provided around the body, a heating device provided in the body or the drying device and electrically connected to the electrical connection portion, and a sealing cover. The body or the drying device is provided with a groove provided with an exhaust port and an inlet port on a wall thereof. The electrical connection portion is provided on the wall of the groove. The sealing cover is provided in the groove. When the sealing cover is removed from the groove, the power cord is inserted into the electrical connection portion and supplies power to the heating device, the heating device heats the drying device, moisture and hot air are discharged through the exhaust port, and air enters the body through the inlet port.

### CROSS-REFERENCE TO RELATED APPLICATION

This application claims the priority of Taiwanese patent application No. 112212178, filed on Nov. 9, 2023, which is incorporated herewith by reference.

### BACKGROUND OF THE INVENTION

### 1. Field of the Invention

The present invention relates to a sealed container, and more particularly, to a sealed container with heating-regeneration and drying-dehumidifying functions.

### 2. The Prior Arts

Sealed containers that store contents (e.g., medicines or food) usually have a sealing strip to prevent moisture from entering. However, when the sealed container is opened, moisture may enter the container, causing the contents to be damped.

In order to solve the above problems, a desiccant is usually placed in the sealed container, and the desiccant can adsorb moisture to keep the contents dry, thereby the effect of dehumidification is achieved, and the damp degree of the contents can be reduced. Food-grade desiccants include quicklime desiccant, silica gel desiccant, montmorillonite desiccant, calcium chloride desiccant and silica desiccant. Among the above-mentioned desiccants, only silica gel desiccant is reusable, while the other desiccants can only be used once. Silica gel desiccant usually is added with a moisture content indicator (beads in blue color) to help the indication of the status of the moisture content in the silica gel desiccant. The silica gel desiccant will turn from blue to pink when it adsorbs moisture. When performing heating-regeneration on the silica gel desiccant, the silica gel desiccant can be taken out of the sealed container and then placed in an oven to be baked or placed under the sun to be dried, such that the silica gel desiccant returns from pink to blue.

However, when the silica gel desiccant is in a hygroscopic state, the user must open the sealed container before taking out the silica gel desiccant to perform the heating-regeneration process, which is not only inconvenient, and the contents are easily damped.

### SUMMARY OF THE INVENTION

A main object of the present invention is to provide a sealed container with heating-regeneration and drying-dehumidifying functions, in which the drying device can be regenerated by heating.

In order to achieve the aforementioned object, the present invention provides a sealed container with heating-regeneration and drying-dehumidifying functions, comprising a body, a drying device, an electrical connection portion, a sealing structure, a heating device and a sealing cover. The drying device is provided in the body, wherein one of the body and the drying device is provided with a groove, and the groove is provided with an exhaust port and an inlet port on a wall thereof. The electrical connection portion is provided on the wall of the groove. The sealing structure is provided around the body. The heating device is provided in the body or the drying device and electrically connected to the electrical connection portion. The sealing cover is provided in the groove. Wherein when the sealing cover is removed from the groove, the electrical connection portion is used for a power cord to be inserted therein and to supply power to the heating device, and the heating device is used to heat the drying device, the exhaust port is used to discharge moisture and hot air located at inside of the body as well as adsorbed by the drying device outward, and the inlet port is used to allow air from an external space to pass therethrough and enter the inside of the body.

In some embodiments, the body includes a pedestal, an upper cover and a plurality of partitions, the upper cover is provided on the pedestal, the partitions are provided in the pedestal and divide inside of the pedestal into a plurality of compartments, each of the partitions is provided with a via hole through which the compartments communicate with each other, one of the compartments is defined as an accommodating tank, the groove is provided at one side of the pedestal, the exhaust port communicates with the accommodating tank, the drying device is provided in the accommodating tank, and the sealing structure is provided around the pedestal.

In some embodiments, the drying device includes a base and a first desiccant, the base is provided in the accommodating tank and has an upper chamber, the upper chamber is provided with a plurality of through holes on a wall thereof, the through holes communicate with the accommodating tank, and the first desiccant is placed in the upper chamber.

In some embodiments, the drying device further includes a second desiccant, the second desiccant is placed in the accommodating tank and located below the base.

In some embodiments, the heating device includes a heater and a heat conduction plate, the heater is provided in the accommodating tank, located above the second desiccant, and electrically connected to the electrical connection portion, and the heat conduction plate is provided at a bottom of the heater.

In some embodiments, the body includes a pedestal and an upper cover, the upper cover is provided on the pedestal and provided with an accommodating tank, the sealing structure is provided around the upper cover, the drying device is provided in the accommodating tank and provided with the groove, and the exhaust port communicates with the accommodating tank.

In some embodiments, the drying device includes a base, a first desiccant and at least one gasket, the base is provided in the accommodating tank and has an upper chamber, a lower chamber and the groove, the upper chamber is provided with a plurality of through holes on a wall thereof, the through holes communicate with the lower chamber, the first desiccant is placed in the upper chamber, and the at least one gasket is provided around the base, such that the base is fixed in the accommodating tank.

In some embodiments, the drying device further includes a second desiccant and a partition mesh, the second desiccant is placed in the lower chamber, the partition mesh is provided at a bottom of the lower chamber and provided with a plurality of perforations, and the perforations communicate with the lower chamber.

In some embodiments, the heating device includes a heater and a heat conduction plate, the heater is provided in the lower chamber, located above the second desiccant, and electrically connected to the electrical connection portion, and the heat conduction plate is provided at a bottom of the heater.

In some embodiments, the drying device further includes a transparent cover, the transparent cover is provided at an opening of the upper chamber.

In some embodiments, the drying device is detachable from the body.

In some embodiments, the sealed container further comprises a fan, which is provided in the body, close to the exhaust port, and electrically connected to the electrical connection portion; wherein the body has a surrounding wall on an inner wall thereof, the surrounding wall is located between the exhaust port and the inlet port and is used to separate the exhaust port from the inlet port; wherein when the sealing cover is removed from the groove, the electrical connection portion is used to supply power to the fan, the moisture and the hot air are discharged outward through the fan and the exhaust port by a guidance of an air flow, while the air from the external space passes through the inlet port and enters the inside of the body by the guidance of the air flow.

In some embodiments, the sealed container further comprises a labeling portion, which is provided on the body or the drying device and is used to indicate whether the drying device is in a dry state or a hygroscopic state.

In some embodiments, the sealed container further comprises an indicator light, which is provided in the groove and is used to indicate whether the heating device is in a heating state or a cooling state.

The effect of the present invention is that in the sealed container, the heating device can be used to regenerate the drying device by heating, and there is no need to open the body to take out the drying device at all, which is very convenient, and the damp degree of the contents stored inside the pedestal can be reduced.

### BRIEF DESCRIPTION OF THE DRAWINGS

FIG. 1 is a perspective view of a first embodiment of the present invention.

FIG. 2 is an exploded view of the first embodiment of the present invention.

FIG. 3 is a perspective view showing that an electrical connection portion, a heating device and a fan are separated from a pedestal according to the first embodiment of the present invention.

FIG. 4 is a perspective view showing that moisture flows in the pedestal according to the first embodiment of the present invention.

FIG. 5A is a cross-sectional view showing that the moisture enters the accommodating tank and the upper chamber according to the first embodiment of the present invention.

FIG. 5B is a schematic diagram of area A of FIG. 5A.

FIG. 6 is a top view showing that the first desiccant is in a hygroscopic state according to the first embodiment of the present invention.

FIG. 7 is a perspective view showing the performing of heating-regeneration according to the first embodiment of the present invention.

FIG. 8 is a schematic diagram showing that the moisture and hot air in the accommodating tank are discharged outward through the fan and the exhaust port according to the first embodiment of the present invention.

FIG. 9 is a schematic diagram showing that air from an external space enters the inside of the body through the inlet port according to the first embodiment of the present invention.

FIG. 10 is a top view showing that the first desiccant is regenerated to a dry state by heating according to the first embodiment of the present invention.

FIG. 11 is a perspective view of a second embodiment of the present invention.

FIG. 12 is an exploded view of the second embodiment of the present invention.

FIG. 13 is a perspective cross-sectional view of the second embodiment of the present invention.

FIG. 14A is a schematic diagram showing that moisture enters the lower chamber through the perforations and enters the upper chamber via the through holes according to the second embodiment of the present invention.

FIG. 14B is a schematic diagram of area B of FIG. 14A.

FIG. 15 is a top view showing that the first desiccant is in a hygroscopic state according to the second embodiment of the present invention.

FIG. 16 is a perspective view showing the performing of heating-regeneration according to the second embodiment of the present invention.

FIG. 17 is a schematic diagram showing that the moisture and hot air in the lower chamber are discharged outward through the fan and the exhaust port according to the second embodiment of the present invention.

FIG. 18 is a schematic diagram showing that air from an external space enters the inside of the body through the inlet port according to the second embodiment of the present invention.

FIG. 19 is a top view showing that the first desiccant is regenerated to a dry state by heating according to the second embodiment of the present invention.

FIG. 20 is a schematic diagram showing that the drying device is separated from the body according to the second embodiment of the present invention.

### DETAILED DESCRIPTION OF THE PREFERRED EMBODIMENT

Herein after, a more detailed description of the implementations of the present invention is made with reference to drawings and reference numerals, in order that those skilled in the art can implement them after studying this specification.

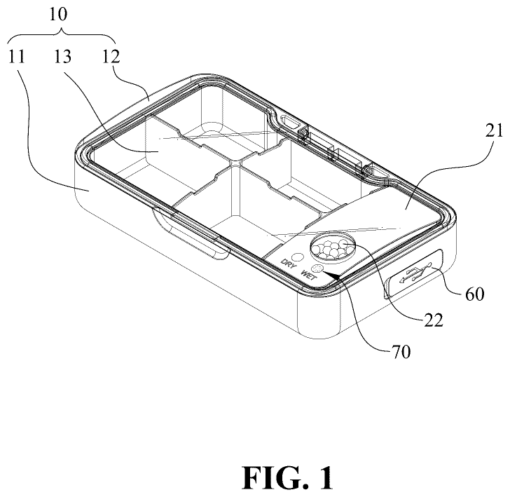

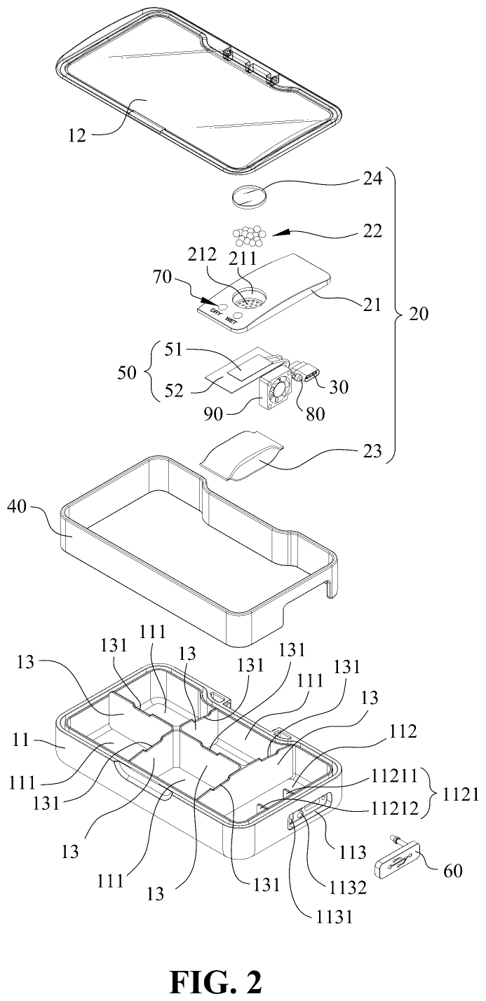

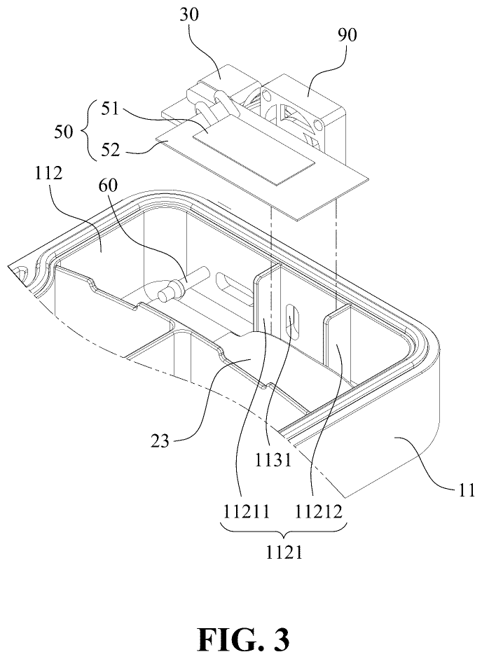

FIG. 1 is a perspective view of a first embodiment of the present invention. FIG. 2 is an exploded view of the first embodiment of the present invention. FIG. 3 is a perspective view showing that an electrical connection portion 30, a heating device 50 and a fan 90 are separated from a pedestal 11 according to the first embodiment of the present invention. As shown in FIGS. 1, 2 and 3, the present invention provides a sealed container with heating-regeneration and drying-dehumidifying functions, comprising a body 10, a drying device 20, an electrical connection portion 30, a sealing structure 40, a heating device 50, a sealing cover 60, a labeling portion 70, an indicator light 80 and a fan 90. The body 10 includes a pedestal 11, an upper cover 12 and a plurality of partitions 13. The upper cover 12 is provided on the pedestal 11. The partitions 13 are provided in the pedestal 11 and divide the inside of the pedestal 11 into a plurality of compartments 111, each of the partitions 13 is provided with a via hole 131, and the compartments 111 communicate with each other through the via holes 131. One of the compartments 111 is defined as an accommodating tank 112. The accommodating tank 112 has a surrounding wall 1121 on the inner wall thereof, the surrounding wall 1121 includes a first side wall 11211 and a second side wall 11212, and the second side wall 11212 is located at an opposite side of the first side wall 11211. A groove 113 is provided at one side of the pedestal 11, and the groove 113 is provided with an exhaust port 1131 and an inlet port 1132 on the wall thereof. Both the exhaust port 1131 and the inlet port 1132 communicate with the accommodating tank 112, and the first side wall 11211 is located between the exhaust port 1131 and the inlet port 1132. The drying device 20 includes a base 21, a first desiccant 22, a second desiccant 23 and a transparent cover 24. The base 21 is provided in the accommodating tank 112 and has an upper chamber 211, the upper chamber 211 is provided with a plurality of through holes 212 on the wall thereof, and the through holes 212 communicate with the accommodating tank 112. The first desiccant 22 is placed in the upper chamber 211. The second desiccant 23 is placed in the accommodating tank 112 and located below the base 21. The transparent cover 24 is provided at the opening of the upper chamber 211. The electrical connection portion 30 is provided on the wall of the groove 113. The sealing structure 40 is provided around the pedestal 11. The heating device 50 includes a heater 51 and a heat conduction plate 52. The heater 51 is provided in the accommodating tank 112, located above the second desiccant 23, and electrically connected to the electrical connection portion 30. The heat conduction plate 52 is provided at the bottom of the heater 51. The sealing cover 60 is provided in the groove 113. The labeling portion 70 is provided on the surface of the base 21 and includes texts and patterns. The indicator light 80 is provided in the groove 113 and electrically connected to the electrical connection portion 30. The fan 90 is provided in the accommodating tank 112, located between the first side wall 11211 and the second side wall 11212, close to the exhaust port 1131, and electrically connected to the electrical connection portion 30.

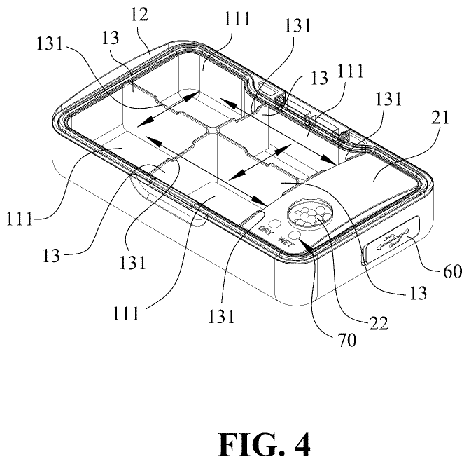

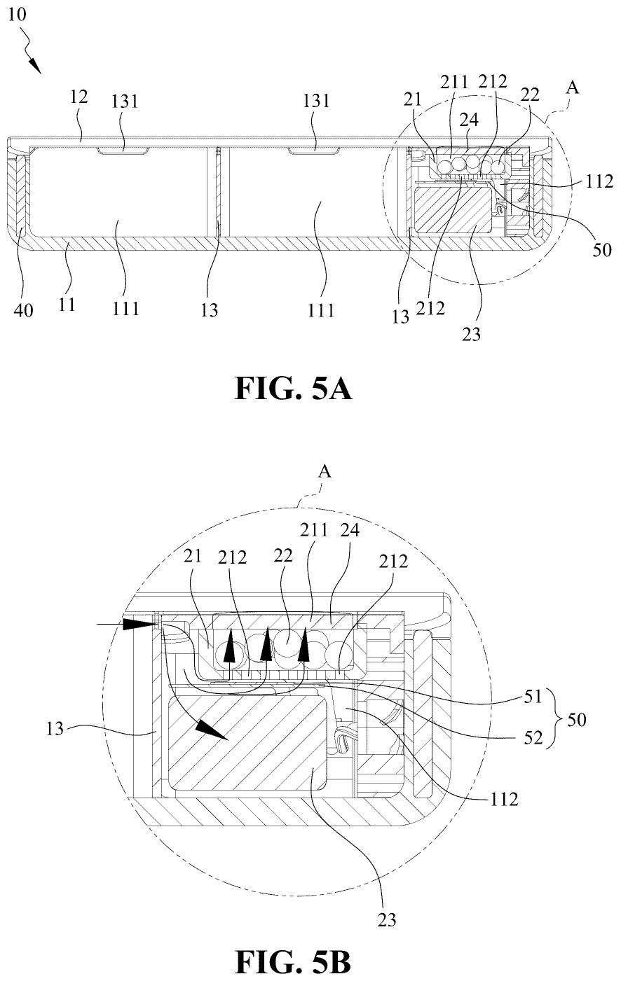

FIG. 4 is a perspective view showing that moisture flows in the pedestal 11 according to the first embodiment of the present invention. FIG. 5A is a cross-sectional view showing that the moisture enters the accommodating tank 112 and the upper chamber 211 according to the first embodiment of the present invention. FIG. 5B is a schematic diagram of area A of FIG. 5A. As shown in FIGS. 4, 5A and 5B, in the first embodiment, when the upper cover 12 and the sealing structure 40 jointly close the compartments 111 and the sealing cover 60 closes the groove 113, the air inside the compartments 111 can flow among the compartments 111 through the via holes 131, the moisture inside the compartments 111 can enter the accommodating tank 112 through the via holes 131, the second desiccant 23 adsorbs the moisture in the accommodating tank 112, a part of the moisture in the accommodating tank 112 enters the upper chamber 211 via the through holes 212, and the first desiccant 22 adsorbs the moisture in the upper chamber 211. Thereby, the contents (e.g., medicines or food) stored in the compartments 111 can be kept dry, thereby the effect of dehumidification is achieved, and the damp degree of the contents can be reduced.

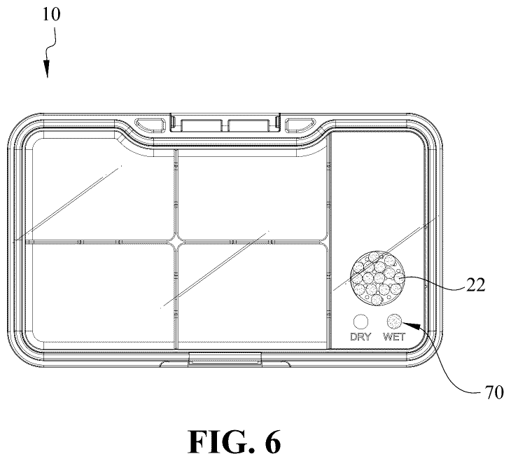

FIG. 6 is a top view showing that the first desiccant 22 is in a hygroscopic state according to the first embodiment of the present invention. In the first embodiment, the first desiccant 22 is added with a moisture content indicator. As shown in FIG. 1, when the first desiccant 22 is in a dry state, the first desiccant 22 is blue in color, the user can see that the first desiccant 22 is blue through the transparent cover 24, and can know that the blue color represents the dry state according to the texts and patterns of the labeling portion 70. As shown in FIG. 6, when the first desiccant 22 is in a hygroscopic state, the first desiccant 22 is pink in color, the user can see that the first desiccant 22 is pink through the transparent cover 24, and can know that the pink color represents the hygroscopic state according to the texts and patterns of the labeling portion 70. In the above embodiment, a color change of the moisture content indicator between blue and pink is taken as an example, but it is not limited thereto, and other color changes are also included in the present invention.

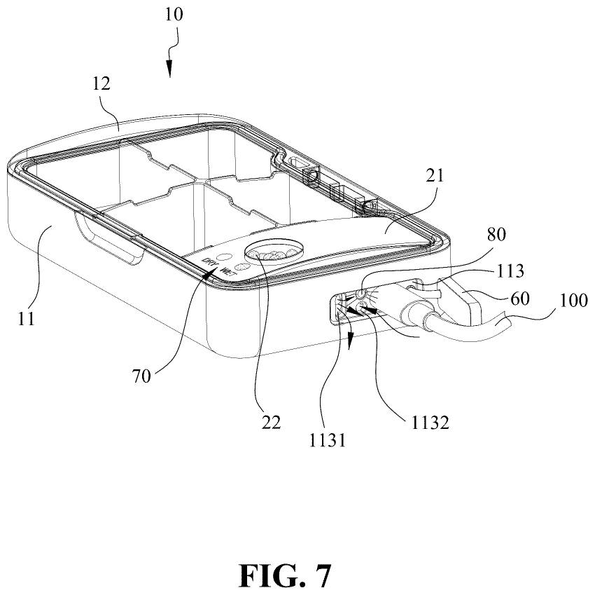

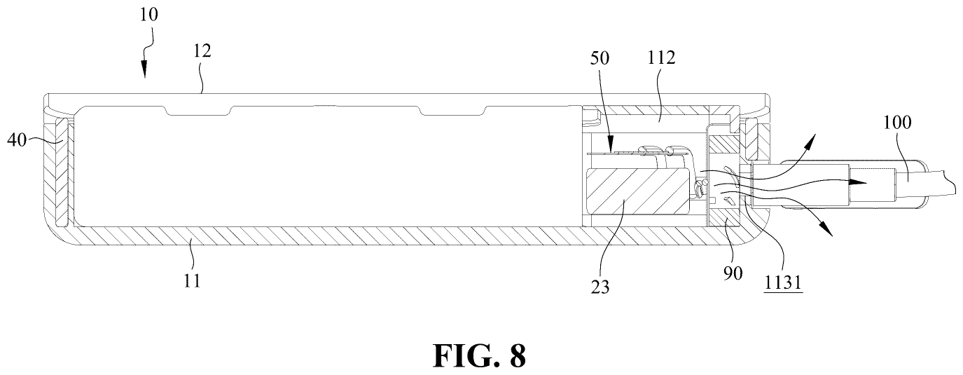

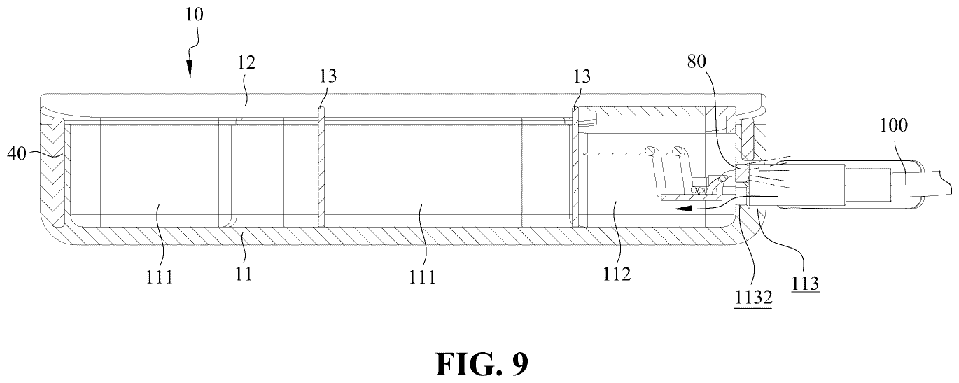

FIG. 7 is a perspective view showing the performing of heating-regeneration according to the first embodiment of the present invention. FIG. 8 is a schematic diagram showing that the moisture and hot air in the accommodating tank 112 are discharged outward through the fan 90 and the exhaust port 1131 according to the first embodiment of the present invention. FIG. 9 is a schematic diagram showing that air from an external space enters the inside of the body 10 through the inlet port 1132 according to the first embodiment of the present invention. As shown in FIGS. 7, 8 and 9, in the first embodiment, when the sealing cover 60 is removed from the groove 113, the electrical connection portion 30 is used for a power cord 100 to be inserted therein and to supply power to the heater 51, the indicator light 80 and the fan 90, the heater 51 transfers heat to the heat conduction plate 52, the heat conduction plate 52 can increase the range of heat transfer, such that the temperature in the accommodating tank 112 rises evenly. At this time, the indicator light 80 is on, indicating that the heater 51 is in a heating state. The hot air in the accommodating tank 112 can evaporate the moisture adsorbed by the second desiccant 23. When the fan 90 is started, the hot air in the accommodating tank 112 can enter the upper chamber 211 via the through holes 212 by the guidance of the air flow, and the hot air in the upper chamber 211 can evaporate the moisture adsorbed by the first desiccant 22. The hot air in the accommodating tank 112 can also flow among the compartments 111 through the via holes 131 by the guidance of the air flow, and the hot air in the compartments 111 can evaporate the moisture adsorbed by the contents. The moisture and hot air in the compartments 111 can enter the accommodating tank 112 through the via holes 131 by the guidance of the air flow, and the moisture and hot air in the upper chamber 211 can enter the accommodating tank 112 via the through holes 212 by the guidance of the air flow. The moisture and hot air in the accommodating tank 112 are discharged outward through the fan 90 and the exhaust port 1131 by the guidance of the air flow, thereby achieving the effect of moisture discharge and heat dissipation. At the same time, the air from the external space passes through the inlet port 1132 and enters the accommodating tank 112 by the guidance of the air flow, so as to maintain the gas circulation flow inside the body 10, thereby preventing the moisture from condensing inside the body 10. The first side wall 11211 is used to separate the exhaust port 1131 from the inlet port 1132, so as to improve the effect of gas circulation flow, thereby preventing the moisture from condensing inside the body 10.

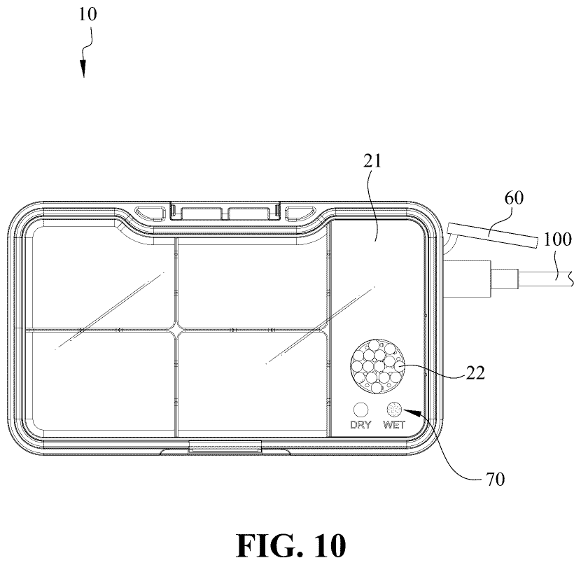

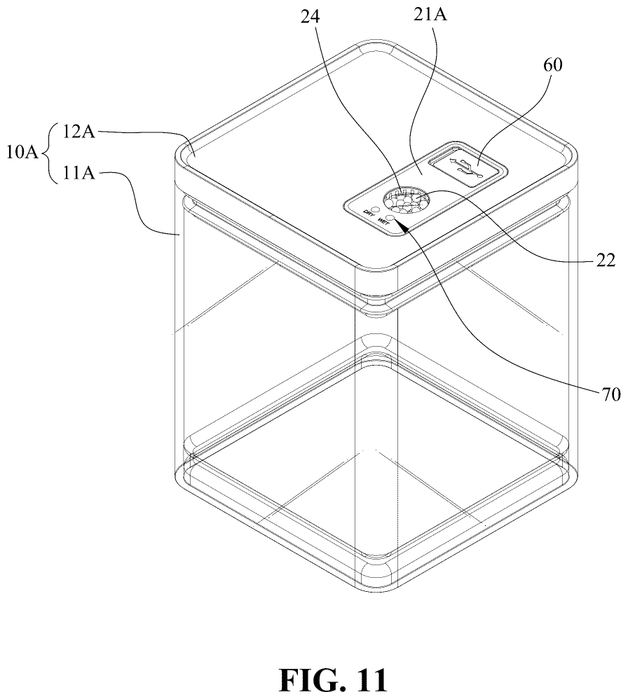

FIG. 10 is a top view showing that the first desiccant 22 is regenerated to the dry state by heating according to the first embodiment of the present invention. As shown in FIG. 10, after all the moisture is discharged outward through the fan 90 and the exhaust port 1131, the user can see that the first desiccant 22 returns from pink to blue through the transparent cover 24, indicating that both the first desiccant 22 and the second desiccant 23 are regenerated to the dry state.

As shown in FIG. 1, after both the first desiccant 22 and the second desiccant 23 are regenerated to the dry state, the power cord 100 can be pulled out from the electrical connection portion 30, then the indicator light 80 turns off, indicating that the heater 51 is in a cooling state, and the sealing cover 60 closes the groove 113 to prevent the moisture from entering the accommodating tank 112 through the exhaust port 1131 and the inlet port 1132.

As shown in FIG. 2, preferably, the first desiccant 22 includes a plurality of granular structures; the second desiccant 23 includes a bag and a plurality of granular structures (not shown) in which the bag covers the granular structures; each of the granular structures is silicone desiccant. The present invention is not limited thereto, and any desiccant that can be regenerated by heating can be used as the granular structures of the first desiccant 22 and the second desiccant 23.

Preferably, because the user cannot see the second desiccant 23, the second desiccant 23 is not added with moisture content indicator to save costs. In some embodiments, the second desiccant 23 may be added with a moisture content indicator.

Preferably, the through holes 212 are provided on the bottom wall of the base 21. Thereby, the moisture or hot air in the accommodating tank 112 can enter the upper chamber 211 vertically via the through holes 212, and the moisture in the upper chamber 211 can also enter the lower chamber vertically via the through holes 212.

Preferably, the heater 51 is a thermal resistor. The present invention is not limited thereto, and any device with a heating function can be used as the heater 51 of the present invention.

Preferably, the heat conduction plate 52 can be made of a material of metal or ceramic. The present invention is not limited thereto, and any material that can conduct heat can be used as the material of the heat conduction plate 52 of the present invention.

In some embodiments, the labeling portion 70 can include a moisture content sensor and a monitor, wherein the moisture content sensor is used to sense the moisture content change of the first desiccant 22, and the result is displayed through the monitor. When the moisture content sensor senses that the first desiccant 22 is in a dry state, the monitor displays the dry state in text, patterns, or a combination thereof. When the moisture content sensor senses that the first desiccant 22 is in a hygroscopic state, the monitor displays the hygroscopic state in text, patterns, or a combination thereof. In these embodiments, neither the first desiccant 22 nor the second desiccant 23 is added with a moisture content indicator to save costs.

In some embodiments, the labeling portion 70 can include a moisture content sensor and a signal light, wherein the moisture content sensor is used to sense the moisture content change of the first desiccant 22, and the result is indicated through the signal light. When the moisture content sensor senses that the first desiccant 22 is in a dry state, the light appears in blue, which indicates the dry state. When the moisture content sensor senses that the first desiccant 22 is in a hygroscopic state, the light appears in pink, which indicates the hygroscopic state. The present invention is not limited thereto, and the color of the signal light can be changed arbitrarily. In these embodiments, neither the first desiccant 22 nor the second desiccant 23 is added with a moisture content indicator to save costs. In the above embodiment, a color change of the signal light between blue and pink is taken as an example, but it is not limited thereto, and other color changes are also included in the present invention.

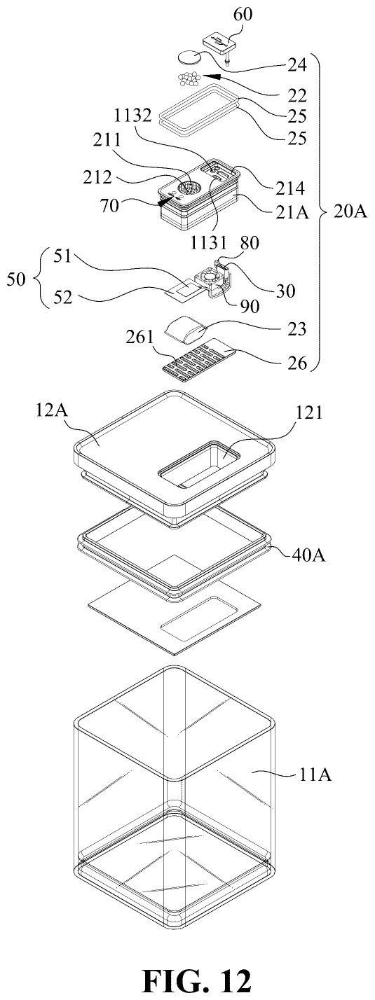

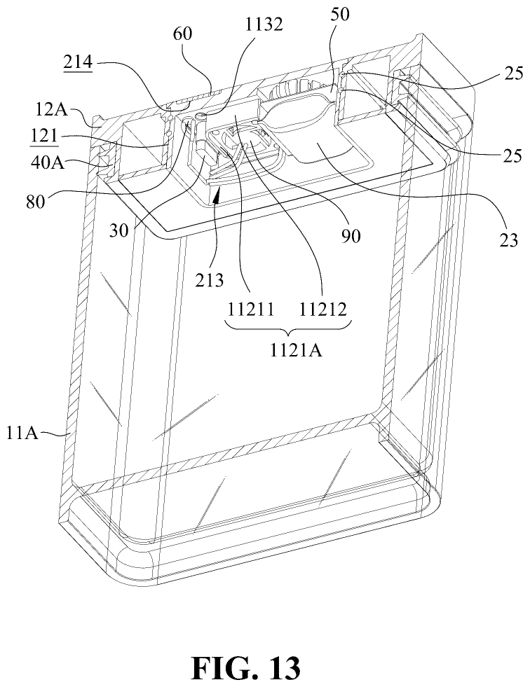

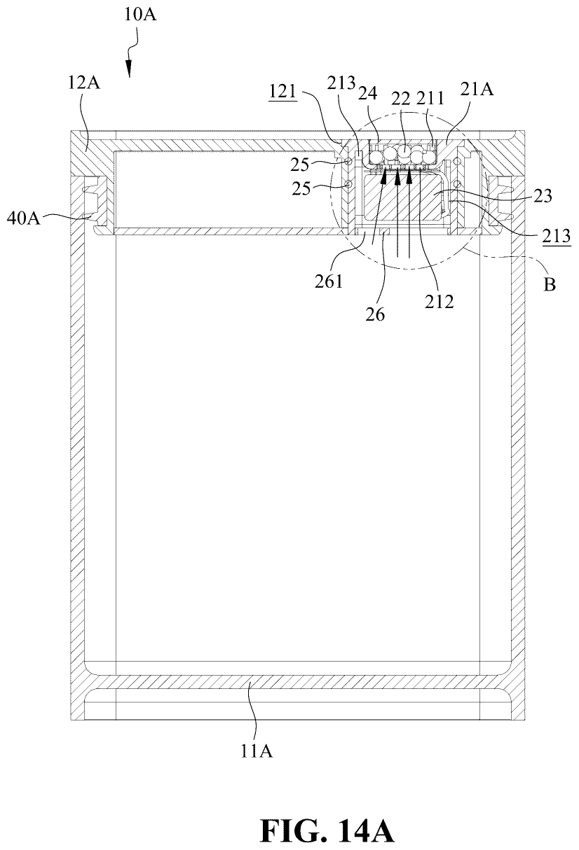

FIG. 11 is a perspective view of a second embodiment of the present invention. FIG. 12 is an exploded view of the second embodiment of the present invention. FIG. 13 is a perspective cross-sectional view of the second embodiment of the present invention. As shown in FIGS. 11, 12 and 13, the second embodiment is different from the first embodiment in that: firstly, a body 10A does not include a plurality of partitions 13, thus a pedestal 11A has only one space therein; secondly, a upper cover 12A is provided with an accommodating tank 121, and a drying device 20A further includes two gaskets 25 provided around a base 21A, such that the base 21A is fixed in the accommodating tank 121; thirdly, the drying device 20A is detachable from the upper cover 12A; fourthly, a sealing structure 40A is provided around the upper cover 12A; fifthly, the base 21A has a lower chamber 213 and a groove 214, wherein both the second desiccant 23 and the heating device 50 are provided in the lower chamber 213, and the through holes 212 communicate with the lower chamber 213; sixthly, the drying device 20A further includes a partition mesh 26, wherein the partition mesh 26 is provided at the bottom of the lower chamber 213 and provided with a plurality of perforations 261, the perforations 261 communicate with the lower chamber 213, and the partition mesh 26 can prevent the second desiccant 23 from falling into the inside of the pedestal 11A; and seventhly, one end of the second side wall 11212 of the surrounding wall 1121A is connected to one end of the first side wall 11211 of the surrounding wall 1121A.

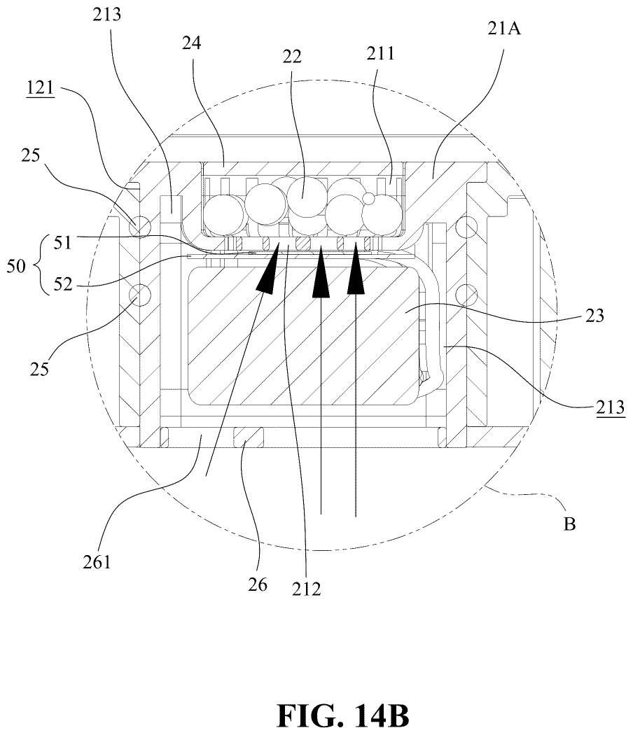

FIG. 14A is a cross-sectional view showing that moisture enters the lower chamber 213 through the perforations 261 and enters the upper chamber 211 via the through holes 212 according to the second embodiment of the present invention. FIG. 14B is a schematic diagram of area B of FIG. 14A. As shown in FIGS. 14A and 14B, in the second embodiment, when the upper cover 12A and the sealing structure 40A jointly close the inside of the pedestal 11A and the sealing cover 60 closes the groove 214, the moisture inside the pedestal 11A enters the lower chamber 213 through the perforations 261, and the second desiccant 23 adsorbs moisture in the lower chamber 213, a part of the moisture in the lower chamber 213 enters the upper chamber 211 via the through holes 212, and the first desiccant 22 adsorbs the moisture in the upper chamber 211. Thereby, the contents (e.g., medicines or food) stored inside the pedestal 11A can be kept dry, thereby the effect of achieve dehumidification is achieved, and the damp degree of the contents can be reduced.

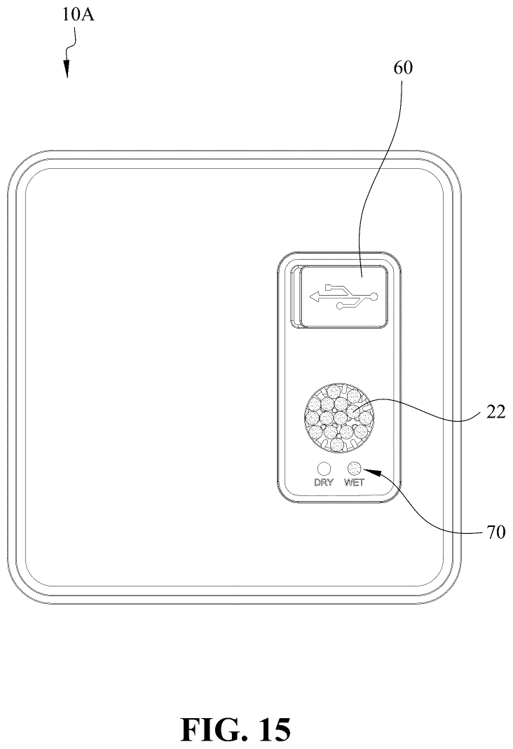

FIG. 15 is a top view showing that the first desiccant 22 is in a hygroscopic state according to the second embodiment of the present invention. In the second embodiment, the first desiccant 22 is added with a moisture content indicator. As shown in FIG. 11, when the first desiccant 22 is in a dry state, the first desiccant 22 is blue in color, the user can see that the first desiccant 22 is blue through the transparent cover 24, and can know that the blue color represents the dry state according to the texts and patterns of the labeling portion 70. As shown in FIG. 15, when the first desiccant 22 is in a hygroscopic state, the first desiccant 22 is pink in color, the user can see that the first desiccant 22 is pink through the transparent cover 24, and can know that the pink color represents the hygroscopic state according to the texts and patterns of the labeling portion 70. In the above embodiment, a color change of the moisture content indicator between blue and pink is taken as an example, but it is not limited thereto, and other color changes are also within the scope to be protected of the present invention.

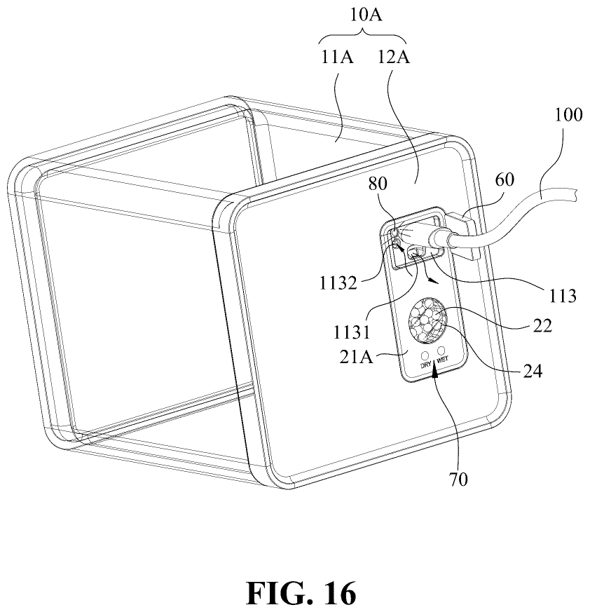

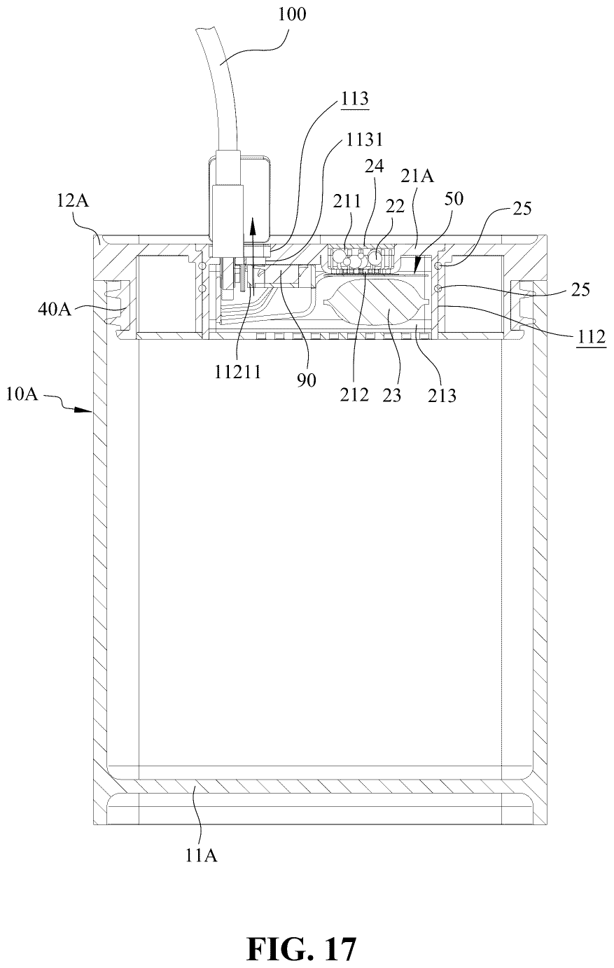

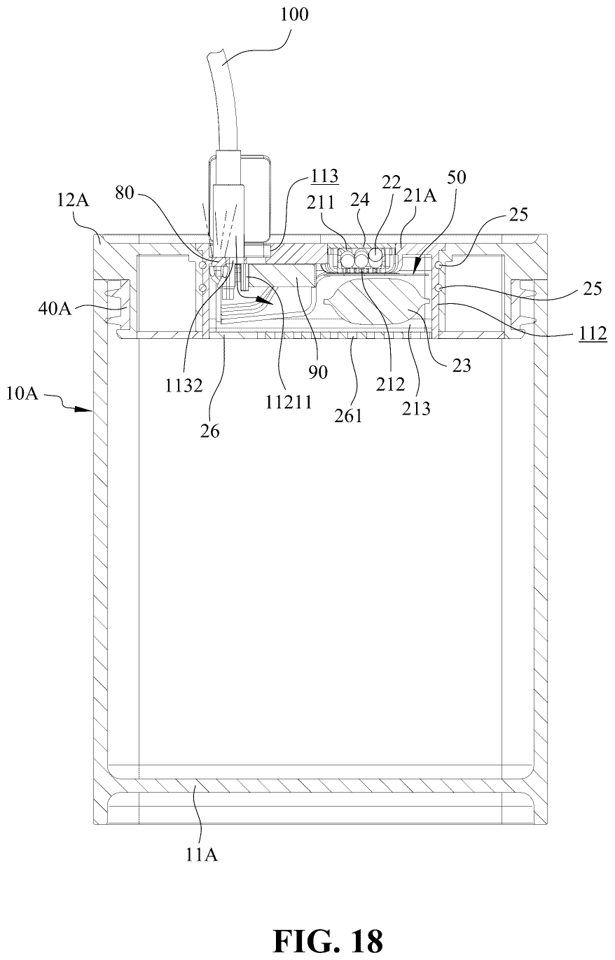

FIG. 16 is a perspective view showing the performing of heating-regeneration according to the second embodiment of the present invention. FIG. 17 is a cross-sectional view showing that the moisture and hot air in the lower chamber 213 are discharged outward through the fan 90 and the exhaust port 1131 according to the second embodiment of the present invention. FIG. 18 is a schematic diagram showing that air from an external space enters the inside of the body 10A through the inlet port 1132 according to the second embodiment of the present invention. As shown in FIGS. 16, 17 and 18, in the second embodiment, when the sealing cover 60 is removed from the groove 214, the electrical connection portion 30 is used for a power cord 100 to be inserted therein and to supply power to the heater 51, the indicator light 80 and the fan 90, the heater 51 transfers heat to the heat conduction plate 52, the heat conduction plate 52 can increase the range of heat transfer, such that the temperature in the lower chamber 213 rises evenly. At this time, the indicator light 80 is on, indicating that the heater 51 is in a heating state. The hot air in the lower chamber 213 can evaporate the moisture adsorbed by the second desiccant 23. When the fan 90 is started, the hot air in the lower chamber 213 can enter the upper chamber 211 via the through holes 212 by the guidance of the air flow, and the hot air in the upper chamber 211 can evaporate the moisture adsorbed by the first desiccant 22. The hot air in the lower chamber 213 can also enter the inside of the pedestal 11A through the perforations 261 by the guidance of the air flow, and the hot air inside the pedestal 11A can evaporate the moisture adsorbed by the contents. The moisture and hot air inside the pedestal 11A can enter the lower chamber 213 through the perforations 261 by the guidance of the air flow, and the moisture and hot air in the upper chamber 211 can enter the lower chamber 213 via the through holes 212 by the guidance of the air flow. The moisture and hot air in the lower chamber 213 are discharged outward through the fan 90 and the exhaust port 1131 by the guidance of the air flow, thereby achieving the effect of moisture discharge and heat dissipation. At the same time, the air from the external space passes through the inlet port 1132 and enters the accommodating tank 112 by the guidance of the air flow, so as to maintain the gas circulation flow inside the body 10A, thereby preventing the moisture from condensing inside the body 10A. The first side wall 11211 is used to separate the exhaust port 1131 from the inlet port 1132, so as to improve the effect of gas circulation flow, thereby preventing the moisture from condensing inside the body 10A.

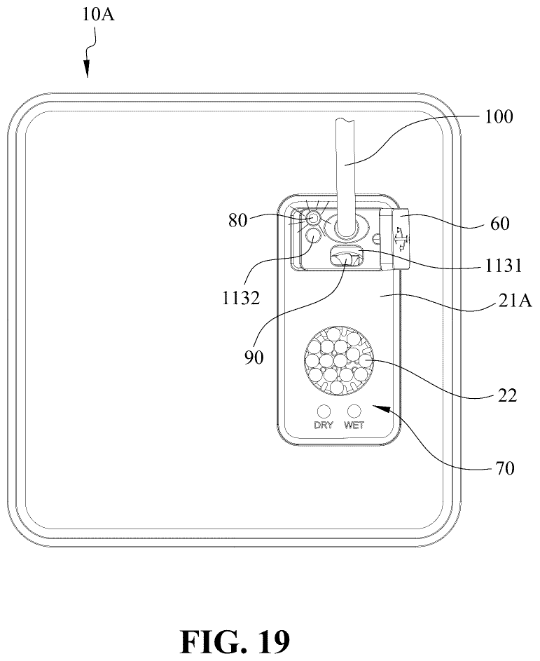

FIG. 19 is a top view showing that the first desiccant 22 is regenerated to the dry state by heating according to the second embodiment of the present invention. As shown in FIG. 19, after all the moisture is discharged outward through the exhaust port 1131, the user can see that the first desiccant 22 returns from pink to blue through the transparent cover 24, indicating that both the first desiccant 22 and the second desiccant 23 are regenerated to the dry state.

As shown in FIG. 11, after both the first desiccant 22 and the second desiccant 23 are regenerated to the dry state, the power cord 100 can be pulled out from the electrical connection portion 30, and the indicator light 80 turns off, indicating that the heater 51 is in a cooling state, and the sealing cover 60 closes the groove 214 to prevent the moisture from entering the accommodating tank 121 through the exhaust port 1131.

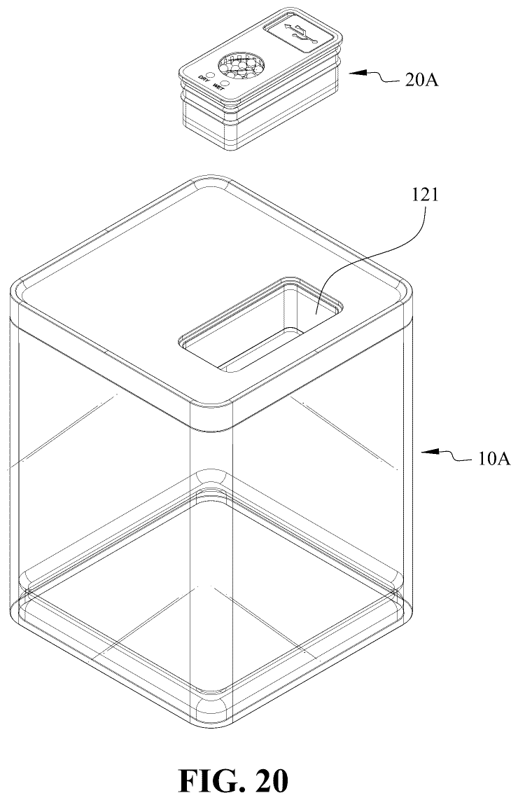

FIG. 20 is a schematic diagram showing that the drying device 20A is separated from the body 10A according to the second embodiment of the present invention. As shown in FIG. 20, since the drying device 20A is detachable from the upper cover 12A, the pedestal 11A, the upper cover 12A and the sealing structure 40A of the body 10A can be cleaned separately.

In summary, in the sealed container of the present invention, the heating device 50 can be used to regenerate the drying devices 20 and 20A by heating, and there is no need to open the bodies 10 and 10A to take out the drying devices 20 and 20A at all, which is very convenient, and the damp degree of the contents stored inside the pedestals 11 and 11A can be reduced.

Those mentioned above are only used to explain the preferred embodiments of the present invention, and are not intended to limit the present invention in any form. Therefore, any modifications or changes to the present invention made under the same creative spirit should still be included in the scope to be protected of the present invention.

What is claimed is:

1. A sealed container with heating-regeneration and drying-dehumidifying functions, comprising:
a body;
a drying device provided in the body, wherein one of the body and the drying device is provided with a groove, and the groove is provided with an exhaust port and an inlet port on a wall thereof;
an electrical connection portion provided on the wall of the groove;
a sealing structure provided around the body;
a heating device provided in the body or the drying device and electrically connected to the electrical connection portion; and
a sealing cover provided in the groove;
wherein when the sealing cover is removed from the groove, the electrical connection portion is used for a power cord to be inserted therein and to supply power to the heating device, and the heating device is used to heat the drying device, the exhaust port is used to discharge moisture and hot air located at inside of the body as well as adsorbed by the drying device outward, and the inlet port is used to allow air from an external space to pass therethrough and enter the inside of the body.

2. The sealed container according to claim 1, wherein the body includes a pedestal, an upper cover and a plurality of partitions, the upper cover is provided on the pedestal, the partitions are provided in the pedestal and divide inside of the pedestal into a plurality of compartments, each of the partitions is provided with a via hole through which the compartments communicate with each other, one of the compartments is defined as an accommodating tank, the groove is provided at one side of the pedestal, the exhaust port communicates with the accommodating tank, the drying device is provided in the accommodating tank, and the sealing structure is provided around the pedestal.

3. The sealed container according to claim 2, wherein the drying device includes a base and a first desiccant, the base is provided in the accommodating tank and has an upper chamber, the upper chamber is provided with a plurality of through holes on a wall thereof, the through holes communicate with the accommodating tank, and the first desiccant is placed in the upper chamber.

4. The sealed container according to claim 3, wherein the drying device further includes a second desiccant, the second desiccant is placed in the accommodating tank and located below the base.

5. The sealed container according to claim 4, wherein the heating device includes a heater and a heat conduction plate, the heater is provided in the accommodating tank, located above the second desiccant, and electrically connected to the electrical connection portion, and the heat conduction plate is provided at a bottom of the heater.

6. The sealed container according to claim 1, wherein the body includes a pedestal and an upper cover, the upper cover is provided on the pedestal and provided with an accommodating tank, the sealing structure is provided around the upper cover, the drying device is provided in the accommodating tank and provided with the groove, and the exhaust port communicates with the accommodating tank.

7. The sealed container according to claim 6, wherein the drying device includes a base, a first desiccant and at least one gasket, the base is provided in the accommodating tank and has an upper chamber, a lower chamber and the groove, the upper chamber is provided with a plurality of through holes on a wall thereof, the through holes communicate with the lower chamber, the first desiccant is placed in the upper chamber, and the at least one gasket is provided around the base, such that the base is fixed in the accommodating tank.

8. The sealed container according to claim 7, wherein the drying device further includes a second desiccant and a partition mesh, the second desiccant is placed in the lower chamber, the partition mesh is provided at a bottom of the lower chamber and provided with a plurality of perforations, the perforations communicate with the lower chamber.

9. The sealed container according to claim 8, wherein the heating device includes a heater and a heat conduction plate, the heater is provided in the lower chamber, located above the second desiccant, and electrically connected to the electrical connection portion, and the heat conduction plate is provided at a bottom of the heater.

10. The sealed container according to claim 3, wherein the drying device further includes a transparent cover, the transparent cover is provided at an opening of the upper chamber.

11. The sealed container according to claim 7, wherein the drying device further includes a transparent cover, the transparent cover is provided at an opening of the upper chamber.

12. The sealed container according to claim 1, wherein the drying device is detachable from the body.

13. The sealed container according to claim 1, further comprising a labeling portion, which is provided on the body or the drying device and is used to indicate whether the drying device is in a dry state or a hygroscopic state.

14. The sealed container according to claim 1, further comprising an indicator light, which is provided in the groove and is used to indicate whether the heating device is in a heating state or a cooling state.

15. The sealed container according to claim 1, further comprising a fan, which is provided in the body, close to the exhaust port, and electrically connected to the electrical connection portion; wherein the body has a surrounding wall on an inner wall thereof, the surrounding wall is located between the exhaust port and the inlet port and is used to separate the exhaust port from the inlet port; wherein when the sealing cover is removed from the groove, the electrical connection portion is used to supply power to the fan, the moisture and the hot air are discharged outward through the fan and the exhaust port by a guidance of an air flow, while the air from the external space passes through the inlet port and enters the inside of the body by the guidance of the air flow.
